(19) United States
(12) Patent Application Publication
(10) Pub. No.: US 2024/0274812 A1
(43) Pub. Date: Aug. 15, 2024

(54) IRON ANODE BATTERY

(71) Applicant: Worcester Polytechnic Institute, Worcester, MA (US)

(72) Inventors: Xiaowei Teng, Durham, NH (US); Sathya N. Jagadeesan, Worcester, MA (US)

(21) Appl. No.: 18/441,249

(22) Filed: Feb. 14, 2024

Related U.S. Application Data
(60) Provisional application No. 63/445,386, filed on Feb. 14, 2023.

(51) Int. Cl. H01M 4/52; H01M 4/02; H01M 10/26; H01M 12/08

(52) U.S. Cl. CPC H01M 4/52; H01M 10/26; H01M 12/08; H01M 2004/021; H01M 2004/027

(57) ABSTRACT

An iron anode employs an electrolyte for generating an anode reaction to convert between Iron II and Iron III ions, denoted by Fe(OH)₂ and FeOOH, rather than tending towards formation of highly stable Fe₃O₄, which can tend to cause “dead” regions in the battery. A suitable battery chemistry includes iron-air and other iron metal batteries operable with an aqueous electrolyte and employing oxygen and water cathodes. The iron anode battery employs inexpensive available iron, rather than more expensive and/or volatile materials used in Li-ion and lead-acid batteries. An aqueous electrolyte formed from sodium hydroxide and silicates, optionally with potassium or chloride salts, forms an anode reaction with nanostructured iron oxide particles in a safe and stable battery chemistry which is readily scalable for grid storage.

### RELATED APPLICATIONS

This patent application claims the benefit under 35 U.S.C. § 119(e) of U.S. Provisional Patent App. No. 63/445,386 filed Feb. 14, 2023, entitled “IRON ANODE BATTERY,” incorporated herein by reference in entirety.

### STATEMENT OF FEDERALLY SPONSORED RESEARCH AND DEVELOPMENT

This patent application was developed, either in whole or in part, with U.S. Government support under Contract Nos. 2222928, 2216047, awarded by the National Science Foundation (NSF). The Government has certain rights in the Invention.

### BACKGROUND

Batteries are devices for storing and releasing electrical energy (power) from an electrochemical reaction. Conventional electrical power is often produced from electromechanical reactions, often from a moving or rotating magnetic source in coil of wire. The magnetic source may be rotated by a fossil fuel powered engine, steam turbine, water driven turbine, or wind driven propeller (windmill). Once generated, electrical energy may be stored in a battery, if not immediately consumed. Intermittent solar and wind sourced electromechanical energy can direct the electric energy to batteries for subsequent delivery. Electrochemical reactions generate an electrical flow based on electron transfer in a chemical reaction, usually from redox (reduction/oxidation) reactions involving ions.

### SUMMARY

An iron anode employs an electrolyte for supporting an anode reaction to convert between Iron II and Iron III ions, denoted by Fe(OH)₂ and FeOOH, rather than tending towards the formation of highly stable Fe₃O₄, which can tend to cause “dead” regions in the battery. A suitable battery chemistry includes iron-air and other iron-metal batteries operable with an aqueous electrolyte and employing oxygen and water cathodes. The iron anode battery employs readily available, inexpensive iron, rather than more expensive and/or volatile materials used in Li-ion and lead-acid batteries. An aqueous electrolyte formed from sodium hydroxide and silicates, optionally with potassium or chloride salts, forms an anode reaction with nanostructured iron oxide particles in a safe and stable battery chemistry which is readily scalable for grid storage.

Batteries are a containment for storing and releasing electrical energy. In simplest terms, batteries provide a containment for storing and releasing electrical energy based on electrochemical reactions occurring in the containment. The battery includes a cathode, an anode, and an electrolyte. A cathode reaction releases electrons for providing an electrical flow, and an anode reaction receives the electrons. An electrolyte between the cathode and anode facilitates ion transfer between the cathode reaction and anode reaction. Respective electrical terminals attached to the cathode and anode provide an electrical connection for directing the electron flow as an electrical current for powering a load (e.g. car, light bulb, motor or electric grid) as the electrons flow from the cathode to the anode. Often the electrochemical reaction is reversible, allowing for a recharging operation to reverse the electric flow and recharge the batteries, also referred to as a secondary battery.

The electrochemical reaction occurs between cathode materials and anode materials which undergo the redox reaction resulting in electron (and thus ion) transfer. The cathode and anode materials can be selected from any suitable material which will result in an electron transfer between the respective chemical species, however many factors enter into the selection of charge materials. The selected anode, cathode and electrolyte materials define the so-called “battery chemistry” of the battery that supports the electrochemical reaction.

Configurations herein are based, in part, on the observation that a variety of battery chemistries are employed for characteristics such as discharge capability, raw materials used and recharge capability. Often these are based on an ability to deliver a consistent, high energy electrical flow. Unfortunately, conventional battery chemistries suffer from the shortcoming that they invoke expensive, harmful and/or potentially volatile materials. Lead-acid batteries are popular as starter batteries in automobiles due to their ability to deliver a short term, high amperage burst, however incorporate a caustic acid that is harmful and corrosive if ruptured. It can also generate hydrogen gas in the case of improper charging and discharging. Lithium-ion (Li-ion) batteries are popular for electronics and electric vehicles (EVs) due to their ability to deliver a consistent energy flow through most of a charge cycle. Li-ion batteries require expensive transition metals such as Ni, Mn and Co, and can also result in dangerously high levels of discharge if improperly handled. Accordingly, configurations herein demonstrate an iron-air battery having an iron based anode that is readily constructed from safe, abundant materials such as iron.

In a particular configuration, discussed further below, a secondary battery device includes an iron based anode formed from nanostructured iron oxide, and a cathode defined by oxygen and air or other suitable material. An electrolyte includes a combination of sodium hydroxide and silicates, and optional salts.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a battery environment suitable for use with configurations herein;

FIG. 2 is a Scanning Electron Microscope (SEM) image of synthesized iron oxides showing the shape of nanorods defining the iron nanoparticles as employed in the anode of FIG. 1;

FIG. 3A shows a Synchrotron X-ray Diffraction (XRD) of the synthesized sample showing the diffraction peaks of FeOOH and Fe₃O₄ formed by the iron anode as in FIGS. 1 and 2;

FIG. 3B shows X-ray photoelectron spectroscopy (XPS) spectra showing the corresponding binding energies of 2p_{1/2} and 2p_{3/2} as in FIG. 3A;

FIG. 4A shows CP (Chronopotentiometry, potential versus capacity) curves of Fe₃O₄ at the current density of 0.1 A g⁻¹ from 0.2 V to −1.05 V;

FIG. 4B shows the derivatives of CP curves showing the additional peak in the presence of silicates;

FIG. 5 shows XRD patterns for the NaOH/silicate/NaCl electrolyte in the iron anode battery of FIGS. 1-4B;

FIG. 6 shows the high conversion between Fe²⁺, from Fe(OH)₂, and Fe³⁺, from FeOOH using the electrolyte as in FIG. 5;

FIG. 7 shows the conversion between Fe²⁺, from Fe(OH)₂, and Fe³⁺, from FeOOH using the NaOH/silicate electrolyte; and

FIGS. 8A and 8B show discharge capacity of Fe₃O₄/FeOOH electrodes measured in full cell setup with NaOH+Na₂SiO₃+Na₂SO₄ electrolyte, compared to NaOH electrolyte.

### DETAILED DESCRIPTION

Metal-air batteries show scalable potential for large scale grid storage. The use of readily available and safe cathode materials eases deployment concerns, even for large scale configurations. Lithium-ion batteries based on intercalation chemistry show high energy density and cycle life, enabling the rapid growth of electric vehicles and portable electronics. However, flammable electrolytes and increasing costs of critical materials have raised concerns for large-scale implementation in stationary storage. Aqueous metal-ion batteries (MIBs), such as metal-air and metal-sulfur chemistries, show great promise in alleviating manufacturing costs and safety concerns by using aqueous electrolytes and earth-abundant materials. Among various MIBs, iron (Fe) alkaline batteries are desirable for high theoretical specific energy due to several merits of Fe materials, such as the multiple electrons transfer redox, high abundance in the earth's crust, low toxicity, and good geographic accessibility. However, the redox chemistry in conventional Fe electrodes shows less than optimal Coulombic efficiency and limited storage capacity, mainly due to Fe₃O₄ and H₂ formation during the discharge and charge processes, respectively. Notably, considerable research efforts have been focused on mitigating hydrogen evolution reaction during the Fe(OH)₂/Fe charge process, e.g., forming the gas-inhibition FeS coating on the electrode surface. However, suppression of Fe₃O₄ formation during the discharge process to allow the Fe(OH)₂/FeOOH redox to realize the full potential of alkaline Fe batteries remains unsettled. Optimizing the interaction between the electrode and electrolyte to tailor the redox chemistry has been a focus of fundamental battery research. Some strategies, including electrolyte additives, artificial coating, and solid electrolytes, have been attempted to improve the electrochemical behaviors during the charge transfer and transport processes. Control of electrolyte additives is likely the most scalable approach due to the simple preparation process and relatively low cost. Successful examples include ‘water-in-salt’ electrolyte or polymer crowding agents to improve the stability of aqueous electrolytes for expanded voltage windows. However, there are few reports on how additives facilitate selective Fe redox chemistry. Therefore, a new strategy to develop low-cost and safe aqueous electrolytes would be beneficial to promote unique battery chemistry mitigating irreversible Fe(OH)₂/FeO₃O₄ redox and enabling high-capacity and reversible Fe(OH)₂/FeOOH redox.

Configurations employing sulfates and chloride salts have been invoked to demonstrate that iron hydroxides are desirable alkaline battery electrodes for low cost and environmental beneficence. However, hydrogen evolution on charging and Fe₃O₄ formation on discharging cause low storage capacity and poor cycling life. Configurations including green rust (GR) (Fe²⁺₄Fe³⁺₂ (HO⁻)₁₂SO₄), formed via sulfate insertion, promote Fe(OH)₂/FeOOH conversion and shows a discharge capacity of ˜211 mAh g⁻¹ in half-cells and Coulombic efficiency of 93% after 300 cycles in full-cells. Theoretical calculations show that Fe(OH)₂/FeOOH conversion is facilitated by intercalated sulfate anions. Classical molecular dynamics simulations reveal that electrolyte alkalinity strongly impacts the energetics of sulfate solvation, and low alkalinity ensures fast transport of sulfate ions. Anion-insertion-assisted Fe(OH)₂/FeOOH conversion, also achieved with Cl⁻ ion, paves a pathway toward efficient utilization of Fe-based electrodes for sustainable applications.

Further improvements mitigate the formation of problematic Fe₃O₄ in favor of Fe(OH)₂/FeOOH conversion (Iron^{II}/Iron^{III}) in the anode reaction through small amounts of silicates in the electrolyte. Configurations herein demonstrate a secondary (rechargeable) battery device having an iron based anode formed from nanostructured iron oxide, and a cathode defined by oxygen and air or other suitable cathodes. An electrolyte including a combination of sodium hydroxide and silicate electrolyte favors a discharge reaction of Fe(OH)₂ to FeOOH over Fe₃O₄ to FeOOH, as discussed further below.

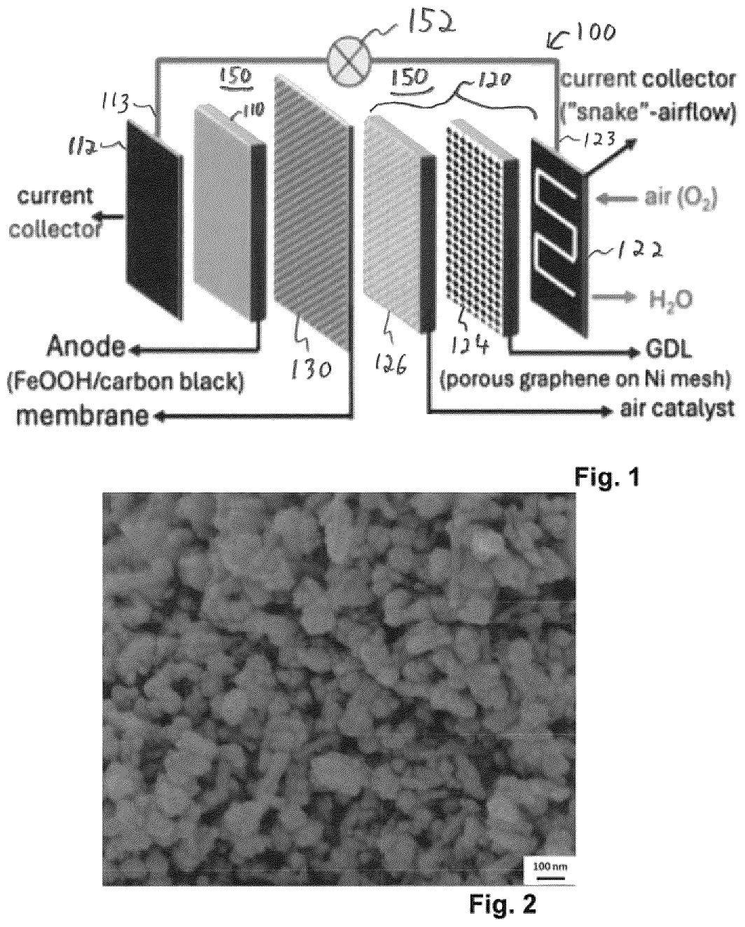

FIG. 1 is a schematic diagram of a battery environment suitable for use with configurations herein. In a metal-air battery 100, anode material forms an anode 110 adhered to an anode current collector 112. A cathode 120 includes a cathode current collector 122, a gaseous diffusion layer (GDL) 124 and an air catalyst 126. A separator or membrane 140 separates the anode and cathode sides and allows for ion/electron diffusion, and a liquid electrolyte 150 surrounds the anode 110, cathode 120 and separator 130 in a containment defining the battery enclosure. Respective terminals 123, 113 in electrical communication with the cathode 122 and anode 112, complete an electric circuit with a load 152, where the electrolyte is an aqueous solution in communication with the cathode and anode for enabling respective anode and cathode reactions for generating electrons from the ions exchanged in the anodic and cathodic reactions.

In a particular configuration, an iron-air battery as in FIG. 1 implements a method of forming an anode in a battery containment including an air based cathode, and an iron based anode where the anode is formed from nanostructured iron oxide. The electrolyte includes a combination of sodium hydroxide and silicates, and optional salts. The resulting high-performance Fe anode system is thus comprised of nanostructured iron oxides and hydroxides, as well as the conditioned electrolytes constituted of mildly alkaline solution (e.g., NaOH with pH ranging from 11 to 13) and sodium silicate (Na₂SiO₃) electrolyte additive (with concentration ranging from 150 ppm to 1000 ppm) and other salts (e.g., Na₂SO₄, Na₂CO₃, KCl, K₂SO₄, K₂CO₃, KCl). For example, in one configuration, the silicates form a concentration of between 150-300 ppm of Na₂SiO₃ in the electrolyte. Only a small quantity is needed to be effective, such as silicates comprising 2.1% or less of the electrolyte. Such Fe anode systems allow high-performance Fe(OH)₂/FeOOH and inhibit Fe₃O₄ and H₂ gas formation during discharging and charging processes. This approach provides a path for designing low-cost and safe Fe anode systems for enabling a new type of anode reaction for Fe-air batteries, Fe—Ni batteries, and Fe—S batteries.

FIG. 2 is a Scanning Electron Microscope (SEM) image of synthesized iron oxides showing the shape of nanorods defining the iron nanoparticles as employed in the anode of FIG. 1. In a typical configuration, the nanostructured iron oxide further comprises iron particles having a size in a range between 50 um-200 um. Referring to FIG. 2, the iron oxide material was synthesized using a co-precipitation method by mixing ferrous and ferric sulfates in a basic solution at room temperature. The synthesized iron oxides depict a nanorod morphology from SEM analysis as shown.

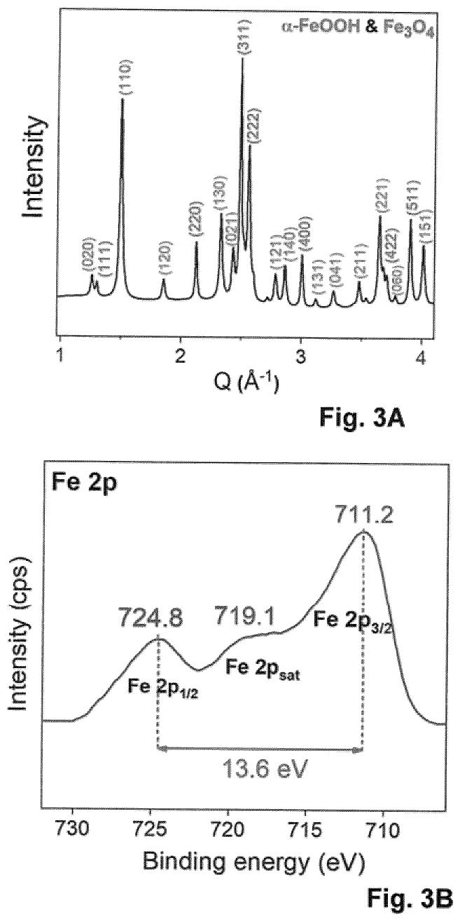

FIG. 3A shows a Synchrotron X-ray Diffraction (XRD) of a synthesized sample showing the diffraction peaks of α-FeOOH and Fe₃O₄ formed by the iron anode as in FIGS. 1 and 2. Referring to FIGS. 1-3A, the Synchrotron XRD shows that the material has diffraction peaks at Q=1.50, 2.33, and 3.65 Å⁻¹ (Q is the momentum transfer and is equal to 2π/d, where d is the interplanar spacing) from the diffraction planes (110), (130), and (221) of goethite (α-FeOOH. The diffraction peaks at Q=2.49, 2.56, and 3.90 Å⁻¹ are from (311), (222), and (511) peaks of magnetite (Fe₃O₄). The Rietveld refinement of XRD patterns showed that the pristine materials constituted 72% α-FeOOH and 28% Fe₃O₄ (weight percentiles).

FIG. 3B shows X-ray photoelectron spectroscopy (XPS) spectra showing the corresponding binding energies of 2p_{1/2} and 2p_{3/2} as in FIG. 3A. Referring to FIGS. 3A-B, the X-ray photoelectron spectroscopy (XPS) depicts Fe 2p spectra of the pristine materials. Notably, Fe 2p_{1/2} and Fe 2p_{3/2} spectra show a binding energy gap of 13.6 eV, confirming mixed valence states of Fe²⁺ and Fe³⁺.

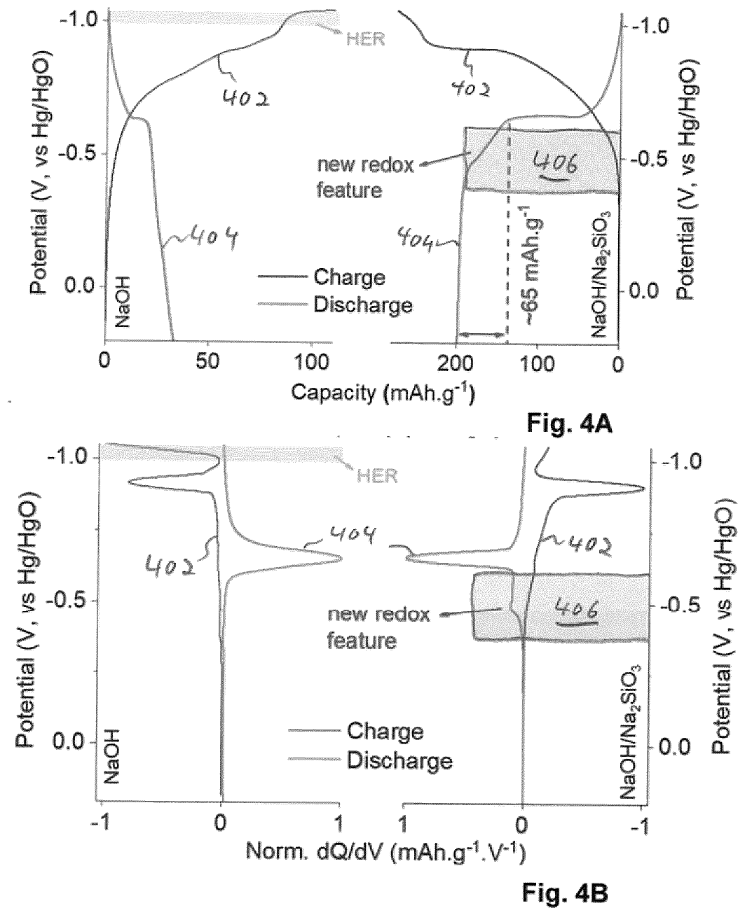

FIG. 4A shows CP curves of Fe₃O₄ at the current density of 0.1 A g⁻¹ from 0.2 V to −1.05 V, and FIG. 4B shows the derivatives of CP curves showing the additional peak in the presence of silicate. Referring to FIGS. 4A-B, FIG. 4A demonstrates chronoamperometry (CP) curves for charge 402 and discharge 404 of iron oxides measured in 0.01 M NaOH solution, with or without Na₂SiO₃ additive, at the current density of 0.1 A g⁻¹ between 0.2 V and −1.05 V (vs. Hg/HgO) in a three-electrode half-cell. FIG. 4B shows the 1st order derivative of discharge capacity with respect to voltage (dQ/dV), calculated from the CP curves. Iron oxides show one charging plateau at −0.91 V and one discharging plateau at −0.65 V in 0.01 M NaOH solution, exhibiting a discharge capacity of 33 mAh g⁻¹. In contrast, when Na₂SiO₃ (150 ppm) was added, materials displayed an improved discharge capacity (199 mAh g⁻¹), six times higher than that in the solution without Na₂SiO₃ additives. Unlike the single plateau in the NaOH electrolyte, CPs in the NaOH/silicate solution show an additional charging plateau at ˜−0.51 V and a discharging plateau at ˜−0.48 V. The new redox feature 406 accounts for an additional discharge capacity of ˜ 65 mAh g⁻¹, which are also discernable in the dQ/dV curve in FIG. 4B. Notably, at the deep charging stage (the voltage decreased from −1.0 to −1.05 V), the plateau appearing in the NaOH electrolyte of FIG. 4A and a substantial reduction feature in the dQ/dV vs. V plot (FIG. 4B) can be attributed to the hydrogen evolution reaction (HER) but is absent in NaOH/Na₂SiO₃ solution, suggesting Na₂SiO₃ suppressed HER. The decreased water activity tends to account for the mitigated HER upon Na₂SiO₃ addition, similar to the reported inhibitive efforts of concentrated salts and molecular crowding agents on HER.

The iron based anode and the sodium hydroxide/silicate based electrolyte support a conversion between iron^{II} and iron^{III} based on oxidation states, depicted by the equations of Table I:

TABLE I

| | |
|---|---|
| FeOOH + H₂O + e⁻ → Fe(OH)₂ + OH⁻ | E = −0.582 V Eq. 1 |
| Fe₃O₄ + 4H₂O + 2e⁻ → 3Fe(OH)₂ + 2OH⁻ | E = −0.876 V Eq. 2 |
| Fe(OH)₂ + 2e⁻ > Fe + 2OH⁻ | E = −0.973 V Eq. 3 |
| Fe₃O₄ + 4H₂O + 8e⁻ → 3Fe + 8OH⁻ | E = −0.935 V Eq. 4 |
| 2H₂O + 2e⁻ → H₂ + 2OH⁻ | E = −0.850 V Eq. 5 |

Returning to the safety and stability of the disclosed approach, Fe-air alkaline batteries are safer than lithium-ion battery (LIB), lead acid battery (LAB), and redox flow battery (RFB) because (i) they use basic solutions and avoid flammable and toxic electrolytes, and (ii) the Fe anode does not form dendrites because redox-active forms of Fe (e.g., Fe(OH)₂ and FeOOH) have low solubilities in alkaline solutions, decreasing the short circuit hazard. As outlined above, a paramount feature is that the anode reaction forms Fe(OH)₂ from FeOOH during discharge, and that the iron based anode and the electrolyte disfavor a formation of Fe₃O₄. The reverse also applies during recharge cycles.

In particular configurations, the electrolyte further includes a salt. As shown below, beneficial performance results from chloride salt, a carbonate salt or a sulfate salt, or in particular, from NaCl, KCl, Na₂SO₄, K₂SO₄, Na₂CO₃ and K₂CO₃ in the aqueous electrolyte, as now discussed further.

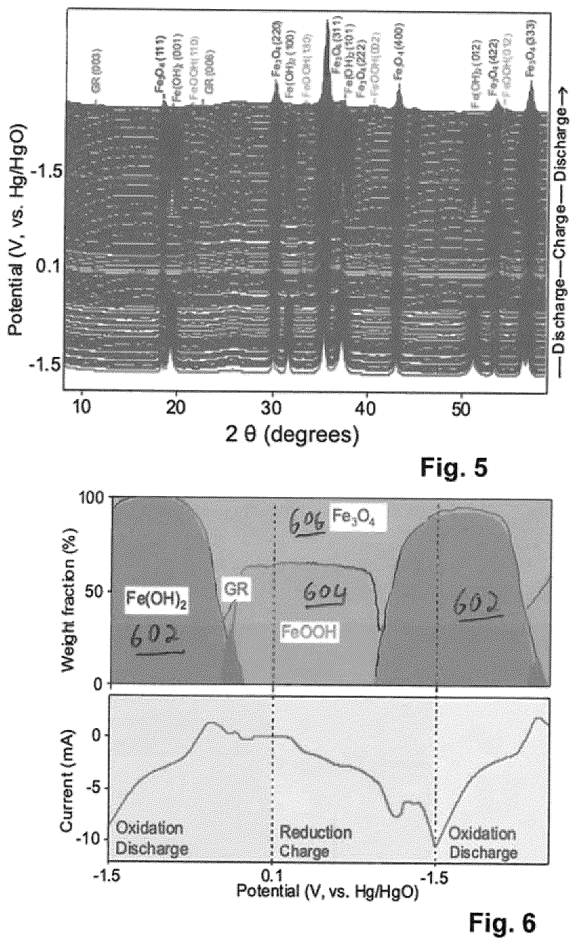

FIG. 5 shows XRD patterns for the NaOH/silicate/NaCl electrolyte in the iron anode battery of FIGS. 1-4B, and FIG. 6 shows the high conversion between Fe²⁺, from Fe(OH)₂, and Fe³⁺, from FeOOH using the electrolyte as in FIG. 5. Referring to FIGS. 5 and 6, formation between Fe(OH)₂ 602 and FeOOH 604 is demonstrated, while Fe₃O₄ 606 is mitigated.

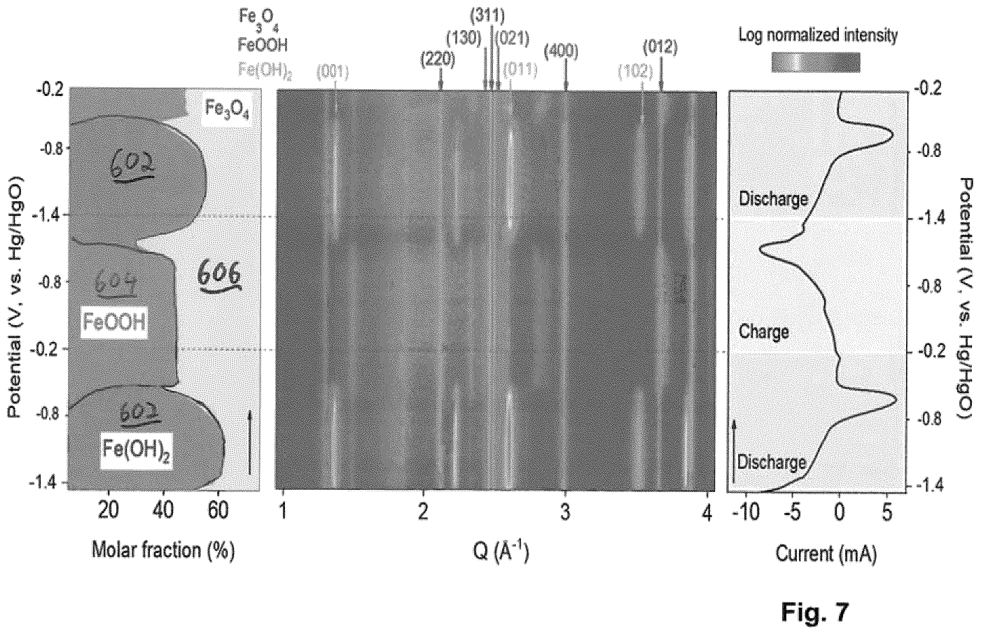

FIG. 7 shows a similar graph for the conversion between Fe²⁺, from Fe(OH)₂, and Fe³⁺, from FeOOH using the NaOH/silicate electrolyte. Example ranges of silicates and salts in the sodium hydroxide electrolyte are shown in Table II:

TABLE II

| | | Higher | Optimized |
|---|---|---|---|
| Components | Lower limit | limit | concentration |
| NaOH | 0.001M | 5M | 0.5~0.005M |
| Silicate | 50 ppm (part per | 2000 ppm | 150~300 ppm |
| (Na₂SiO₃) | million in molar | | |
| | concentration) | | |
| NaCl (or KCl) | 0.005M | 0.5M | 0.2M |
| Na₂SO₄ (or K₂SO₄) | 0.005M | 0.5M | 0.2M |
| Na₂CO₃ (or K₂CO₃ | 0.005M | 1M | 0.4M |

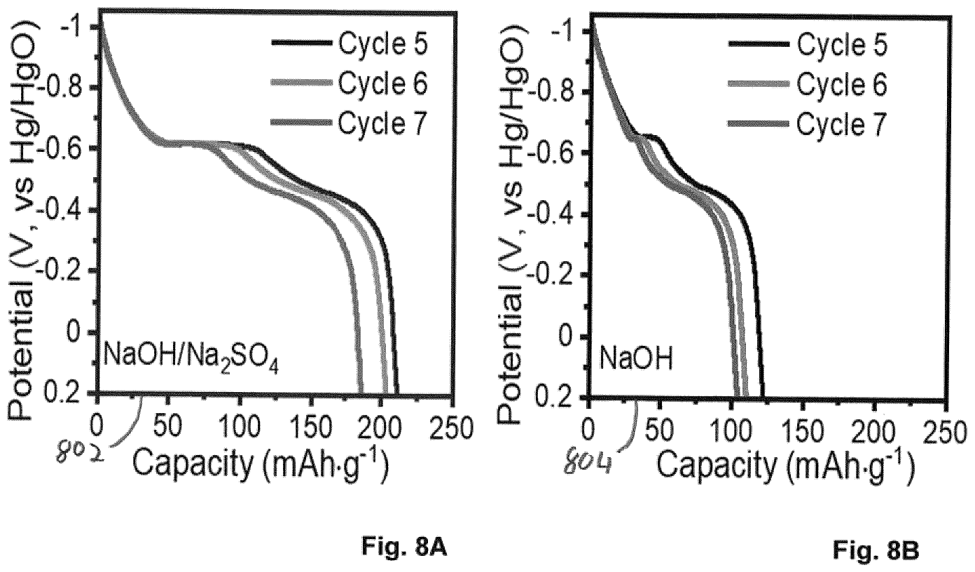

FIGS. 8A and 8B show discharge capacity of Fe₃O₄/FeOOH electrodes measured in full cell setup with NaOH+Na₂SiO₃+Na₂SO₄ electrolyte, compared to NaOH electrolyte. Referring to FIGS. 8A-B, electrochemical performance of Fe(OH)₂/FeOOH redox can be further enhanced using a mixture of at least NaOH, Na₂SiO₃, and further with various salts (e.g., Na₂SO₄, NaCl, and Na₂CO₃), shown in the increased capacity along axis 802, superior to the capacity of NaOH alone, shown along axis 804. The iron oxides in NaOH/Na₂SiO₃ electrolyte have shown almost a two-fold storage capacity as that of the NaOH electrolyte.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A secondary battery device, comprising:
an iron based anode, the anode formed from nanostructured iron oxide;
a cathode defined by oxygen and air; and
an electrolyte including a combination of sodium hydroxide and silicates.

2. The device of claim 1 wherein the nanostructured iron oxide further comprises iron particles having a size in a range between 50 um-200 um.

3. The device of claim 1 wherein the silicates further comprise between 150-300 ppm of Na₂SiO₃ in the electrolyte.

4. The device of claim 1 wherein the silicates comprise 2.1% or less of the electrolyte.

5. The device of claim 1 wherein the electrolyte further comprises a salt.

6. The device of claim 5 wherein the salt is a chloride salt or a sulfate salt and a pH between 11-13.

7. The device of claim 5 wherein the salt is selected from the group consisting of NaCl, KCl, Na₂SO₄, K₂SO₄, Na₂CO₃ and K₂CO₃.

8. The device of claim 1 wherein the iron based anode and the electrolyte support a conversion between iron II and iron III based on oxidation states.

9. The device of claim 1 wherein the iron based anode and electrolyte favor a discharge reaction of Fe(OH)₂ to FeOOH over Fe₃O₄ to FeOOH.

10. The device of claim 1 wherein the iron based anode and the electrolyte disfavor a formation of Fe₃O₄.

11. The device of claim 1 wherein the anode reaction forms Fe(OH)₂ from FeOOH during discharge.

12. The battery device of claim 1, further comprising
a cathode current collector;
an anode current collector; and
respective terminals in electrical communication with the cathode and anode, wherein the electrolyte is an aqueous solution in communication with the cathode and anode.

13. In an iron-air battery, a method of forming an anode, comprising:
providing a containment including:
an air based cathode;
an iron based anode, the anode formed from nanostructured iron oxide; and
an electrolyte, the electrolyte including a combination of sodium hydroxide and silicates.

14. The method of claim 13 wherein the silicates further comprise between 150-300 ppm of Na₂SiO₃ in the electrolyte.

15. The method of claim 14 where the electrolyte further comprises a salt.

16. The method of claim 15 wherein the salt is a chloride salt, a carbonate salt, or a sulfate salt.

17. The method of claim 15 wherein the salt is selected from the group consisting of NaCl, KCl, Na₂SO₄, K₂SO₄, Na₂CO₃ and K₂CO₃.

18. An anode system for an iron-air battery, comprising:
an anode formed from iron nanoparticles; and
an electrolyte defined by an aqueous solution of:
0.001 M to 5.0 M NaOH;
50-2000 ppm silicates; and
0.005 M-1.0 M of a sodium or potassium salt.
